(19) United States
(12) Patent Application Publication
(10) Pub. No.: US 2003/0235163 A1
(43) Pub. Date: Dec. 25, 2003

(54) Wireless packet routing for minimal delay and simplification of packet routing

(75) Inventors: Mark A. Montz, Elkhorn, NE (US); Stanley A. McClellan, Allen, TX (US)

Correspondence Address: CONLEY ROSE, P.C., P. O. BOX 3267, HOUSTON, TX, 77253-3267, US

(73) Assignee: Compaq Information Technologies Group, L.P., Houston, TX

(21) Appl. No.: 10/178,139

(22) Filed: Jun. 24, 2002

(51) Int. Cl. H04Q 7/00

(52) U.S. Cl. 370/331; 370/356

(57) ABSTRACT

A system and method for minimizing wireless packet delay is disclosed. As mobile nodes travel within a wireless communications network, they are transferred (or “handed off”) between zones within the network to maintain continuity of communication. Traditionally, transferring between zones requires the mobile node to notify the network upon travelling to a new zone, and handoff data is then transferred between the mobile and the network before communications can resume. Wireless networks may experience delay and latency in communications due to the mobile node being transferred between zones. In a preferred embodiment of the present invention, the wireless network transmits data preemptively to multiple cells. In selecting which zones data is sent to, prediction algorithms may be employed that monitor information including location of a mobile node and which cells are operational, then a list of candidate cells that the mobile node may enter is generated.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to the routing of packets. More particularly, the present invention relates to the routing of packets in a wireless telecommunications network so as to minimize delay and simplify packet routing.

2. Background of the Invention

As a mobile node (e.g., a cell phone) in a wireless telecommunications network moves geographically, it may transition between zones (called cells) containing different wireless base stations. In order to maintain a user's connection, the communication link to the cell phone must be transferred from one cell to the next such that communication is maintained as the frequencies are switched for the different cells. The transition procedure is known as a “handoff.” The conventional approach for dealing with handoffs of cell phones between cells in a packet-based network typically involves the cell phone notifying the network when it has moved from one cell to another. The network then responds by reconfiguring the necessary elements to route data packets (e.g., handoff information) to the new cell, and retrieve data packets from the old cell. These data packets or handoff data may include email, hypertext transfer protocol (http) requests, file transfer protocol (ftp) requests, etc. This approach is susceptible to service disruptions and latency in that the time it takes the network to determine that a handoff has happened and route the appropriate packets may produce glitches in the data stream. For example, if the data were streaming video, this glitch would produce a pause in the video information that is noticeable by the end user. It should be noted, however, that this delay is not because the network does not have the bandwidth for video data and its data rate, but rather that the routing of packets causes the problem. Additionally, in audio data systems, the glitch may in extreme cases become audibly noticeable (on the order of tenths of seconds, during which time the user may be unable to send/receive voice information), which is unacceptable in voice communications.

### BRIEF SUMMARY OF THE INVENTION

The problems noted above are solved in large part by a wireless telecommunications system that transmits handoff information preemptively to multiple cells. Preferably prediction algorithms monitor, among other things, information including location of a mobile node (e.g., a cell phone) as well as which cells are operational and/or the amount of mobile nodes within a cell. A list of candidate cells that the mobile node may enter is compiled and packet data (e.g., email, hypertext transfer protocol (http) requests, file transfer protocol (ftp) requests etc.) is preemptively sent along to all of the cells in the list, not only to the current cell that the mobile node is in communication with. This packet data may be cached in local memory of the candidate cells making it ready for use by the mobile node. Preemptively sending information to a candidate list of cells allows a reduction in the amount of time it takes a mobile node to receive data from its new cell by as much as three orders of magnitude. In addition, the preferred embodiments of the present invention also allow for standard computer routing equipment to be utilized in lieu of the more complicated, and more costly routing equipment that is traditionally used.

In an alternate embodiment, the wireless telecommunication network simply sends packet data to cells adjacent to the current cell that the mobile node is located in without the aid of predictive algorithms. Therefore, the only information that is required to implement this arrangement is the current location of the mobile node, and this location information is readily available.

### BRIEF DESCRIPTION OF THE DRAWINGS

For a detailed description of the preferred embodiments of the invention, reference will now be made to the accompanying drawings in which:

FIG. 1 shows a wireless cellular network;

FIG. 2 shows a mobile node in communication with a wireless network; and

FIG. 3 shows an exemplary computer.

### NOTATION AND NOMENCLATURE

Certain terms are used throughout the following description and claims to refer to particular system components. As one skilled in the art will appreciate, computer and wireless equipment companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

Before delving into the specifics of wireless packet routing and the preferred embodiments of the invention, it is helpful to give a cursory review of wireless telecommunication and circuit-switched versus packet-switched networks. It should be noted that although this discussion may use the example of a phone as the mobile node in a cellular network, it is not so limited. More broadly, the mobile node may be any electronic device benefiting from packetized data over any wireless infrastructure that utilizes a “handoff” approach. For example, alternate embodiments may include mobile computers communicating in a local wireless network (e.g., computers in police cars). Commonly owned U.S. patent application Ser. No. 10/080,999, filed Feb. 20, 2002, by Kennedy (as incorporated herein by reference) details a portable handheld device that also may benefit from the preferred embodiments of the present invention. Furthermore, a more detailed presentation of related concepts can be found in “Introduction to Telephones and Telephone Systems,” pp. 215-246, by A. Michael Noll, and “Computer Systems Design and Architecture,” pp. 446-449, by Vincent P. Heuring et al. Both of these references are hereby incorporated by reference.

Early mobile two-way radio communications (e.g., police cars, taxis, and ambulances) employed high power transmit-receive devices (commonly called transceivers), that communicated with a single high power central antenna, which could be up to 50 miles away. This often meant that the transceivers had to be high powered enough to communicate with the single central antenna making them, among other things, difficult to transport and undesirable for personal communication use. Also, with a finite selection of frequencies allotted and with separate frequencies used for transmitting and receiving, the number of transmit and receive paths or channels made these early communication systems unavailable for personal communication use.

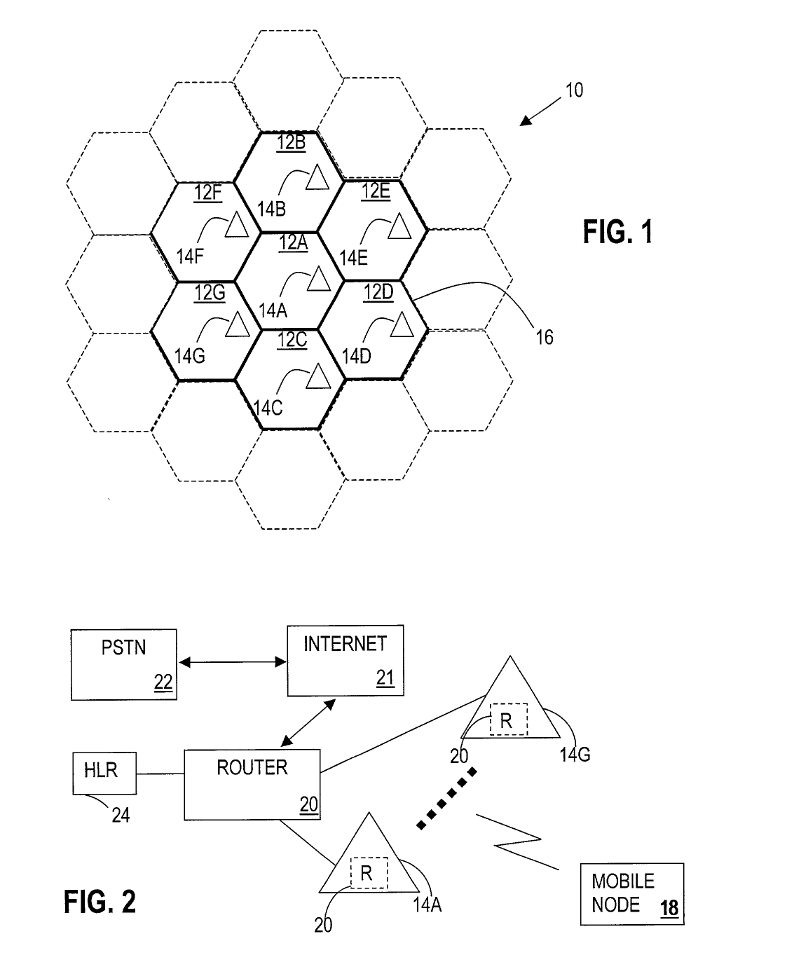

Conventional cell phones are fundamentally two-way radio transceivers. These transceivers communicate to cellular base stations using low power FM modulation. FIG. 1 shows the basic idea of a cellular network 10 in that an area in which communication is desired is divided into small cells 12a-12g. Cells 12a-12g are approximately 6 to 12 miles wide and contain low power transmitters or base stations 14a-14g. Assuming the cells are arranged in a cluster 16, and that there are seven cells 12a-12g in the cluster 16, then the cells may be thought of as hexagonally shaped. By dividing the area into cells, the allotted number of frequencies may be reused such that adjacent cells use separate frequencies and overall interference in the communication area is minimized. However, it should be noted that although the cells are shown as hexagonal for the sake of example in this disclosure, actual implementation may vary.

FIG. 2 shows the mobile node 18 (e.g., cell phone) that may communicate with base stations 14a-14g. The base stations are coupled to the Public Service Telephone Network 22 through the Internet 21 and via a router 20. The router 20 is preferably under the direction of a database called the Home Location Register (HLR) 24, which is described in more detail below. It should be noted that each base station 14 also may include routing abilities in order to further route communications to the proper mobile nodes.

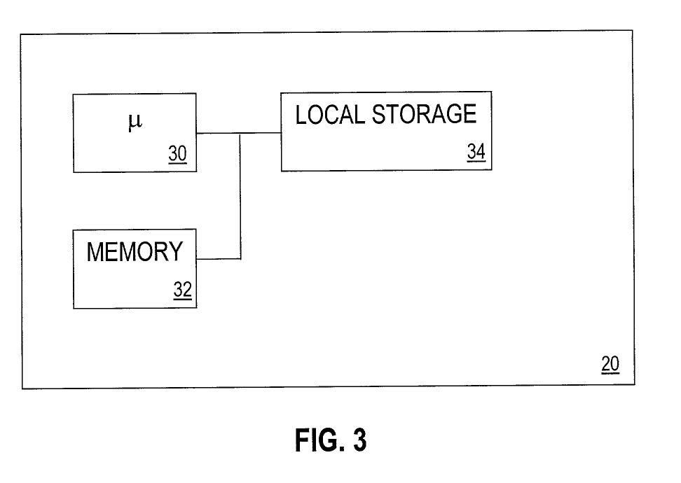

Referring now to FIG. 3, an exemplary router 20 is shown in more detail. The router 20 preferably includes a microprocessor 30, a local storage 34, and a memory unit 32, all of which are coupled to each other. The local storage 34 contains a routing table or address list of all base stations and/or mobile nodes under its administration, and accordingly the router uses this list to route communication to the mobile nodes. It should be noted however that although the term ‘router’ is used herein to discuss a device that routes communication to the proper mobile node, the router may actually be any computer, with various hardware configurations that accomplishes this function (e.g., a computer). In fact, current methods of routing data packets (email, hypertext transfer protocol (http) requests, file transfer protocol (ftp) requests etc.) often include using complicated and expensive hardware that interfaces the database (i.e., Home Location Register) within a specialized router. For example, a General Packet Radio Service (GPRS) based network employs a specialized, and therefore expensive, piece of hardware called a Serving GPRS Service Node (SGSN) to do all of its routing. However, the preferred embodiments of the present invention have advantages over the current methods in that, less complicated and less expensive routers (e.g., the type commonly used in routing data in personal computer based networks), can now be used with minor modifications.

Because the base stations 14 and the mobile node 18 communicate with each other using lower power than earlier methods, the allotted frequencies are now divided among the cells in the cluster and adjacent clusters may reuse the same frequencies, while adjacent cells use distinct frequencies. With each cell in the cluster using a distinct frequency, communication between the mobile node 18 and the base stations 14a-14g becomes more complicated as the mobile node 18 travels through the cellular network 10. The mobile node must be transferred from one cell to the next such that communication is maintained as the frequencies are switched for the different cells.

A mobile node 18 is typically programmed with a System Identification Code (SID), which is a unique 5-digit number that is assigned to each wireless service provider by the Federal Communications Commission (FCC.) The mobile node 18 transmits the SID along with registration data to the HLR 24 at the router 20. Upon verification of the SID, the mobile node is registered with the router 20. The router 20 uses this data to keep track of the mobile node's location within the network so that it knows which cell the mobile node is in and incoming calls can be directed to that cell. The specifics for transferring handoff data are different depending on whether the cellular network is circuit-switched or packet-switched.

Circuit-switching networks create a circuit that reserves the path between two connected parties for the entire communication session. Data networks (like the Internet) on the other hand transfer data much differently using packet-switching. Both circuit-switched and packet-switched networks may break data files into packets if the data exceeds a predetermined size. With packet-switching, routers dynamically determine a path for each individual packet of data, and packets are arbitrarily arranged to use any path available to get to the destination. Unlike circuit-switching, no one data transfer takes up an entire path for an entire transfer session, and data is sent only when data is present. Hence, during pauses in a data transfer, the channel is filled with pieces of other data transfers. Because one transfer does not require an entire circuit, the network can provide what appears to be an “always on” connection, where the user seamlessly can transfer data without having to worry about circuit availability.

Wireless data transfer services (e.g., General Packet Radio Service (GPRS)) are designed to allow packet-based data transmission using existing cellular networks. This approach makes it possible for a cellular subscriber to have a data connection to the Internet, e-mail, files, and faxes anywhere on the cellular network. For example, if someone wanted to receive e-mail while traveling this information could be sent to a mobile node (e.g., a cell phone or a computer connected to a cell phone) using packet-based wireless data transfer services.

The conventional approach for dealing with handoffs of mobile nodes between cells in a packet-based network typically involves the mobile node notifying the network when it has moved from one cell to another. The network then responds by reconfiguring the necessary elements to route data packets (e.g., email, hypertext transfer protocol (http) requests, file transfer protocol (ftp) requests etc.) to the mobile node's new cell, and retrieve data packets from the mobile node's old cell. This approach is susceptible to service disruptions and latency in that, the time it takes the network to determine that a handoff has happened and route the appropriate packets may take several milliseconds.

In accordance with a preferred embodiment of the present invention, network information such as the state of the wireless network and the location of a mobile node is monitored. State of the network information may include which cells are operational and/or the number of mobile nodes within a cell. This network information is gathered and used by a prediction algorithm to determine a list of candidate cells that the mobile node may enter next. In its simplest form, the prediction algorithm computes a static list of cells that a mobile node may move into once it leaves its current cell. For example, as seen in FIG. 1, the mobile node may currently be in cell 12a and would therefore be capable of moving to any one of cells 12b-12g. Yet, a mobile node in cell 12d may only next enter cells 12a, 12c or 12e or leave the cluster 16 altogether. However the predictive algorithm is not so limited, it may incorporate information like current geographic location, global positioning system (GPS) capabilities, and/or radio signal strength in making intelligent decisions about which cells a user should use next. For example, if a user is travelling parallel to one side of a canyon and geographic information reveals that there are no possible bridges across the canyon for another 100 miles, then the predictive algorithm could limit the possible candidate list accordingly. Also, the mobile node may make radio signal strength measurements for the surrounding base stations and develop a list of base stations that it has the best communications (i.e., strongest signals) with. This list could then be transferred to the network prior to the mobile node requesting handoff so that the mobile node would communicate through the best possible communication channel.

Once the list of candidate cells is compiled, packet data that the mobile node may be requesting (e.g., email, hypertext transfer protocol (http) requests, file transfer protocol (ftp) requests, etc.) is preemptively sent along to all of the cells in the list and not just to the mobile node's current cell. For the sake of this disclosure, the term “preemptive” means that the packet data is sent before the mobile node requests it from that cell. This packet data for example may include among other things, email that was in the process of being downloaded when the mobile switches cells. This packet data preferably is cached in local memory, for example in the local memory of router 23, and is ready to be used by the mobile node. By preemptively sending information to a candidate list of cells, a mobile node may be ready to receive data from its new cell in significantly less time (e.g., on the order of microseconds). When a mobile node is transitioning between cells, the cellular network is typically configured to communicate with the mobile node for at least 30 seconds before handing the mobile node off from its current cell. This gives the network ample time to preemptively send information to cells on the candidate list before the mobile node is actually transferred to its new cell. In addition, the mobile node may begin communications immediately instead of waiting for the network to acknowledge it in another cell and react accordingly.

The packet data sent may include email, hypertext transfer protocol (http) requests, file transfer protocol (ftp) requests, as well as other data for services. Data that is cached into local memory is preferably either delivered if the mobile node happens to enter the cell, or is discarded after a predetermined period of time. Typically this predetermined time period is small and depends on the time it takes the mobile node to stop receiving data on one cell, and transition to another cell (i.e., microseconds). Therefore, after this predetermined period of time, the system may assume that the data packet was received either in the original cell or in the new cell it moved to, and in either case the data may be discarded. Other information gathered for use in the prediction algorithm may include the cell that serves a user's home or work location and a usual path from home to work. This information may then be coupled with the cells that are in this path so that the prediction algorithms may curtail a handoff scheme for a particular mobile node at different times of the day.

In another embodiment, prediction algorithms may not be used and the network may simply relay data packets to cells adjacent to the mobile node's current cell. In this manner, the only information needed is the location of the mobile device in the network, and this information is typically readily available.

It should be noted that although the bandwidth requirements to the cell are generally increased by the aforementioned embodiments, traditional networks utilize copper wiring or fiber optic cabling as a backbone, and therefore have more than enough capacity to handle the increase. Also, the added memory required to cache the preemptive data is a minimal concern because the data is purged from memory periodically, and the data is typically only stored for a relatively short time period. Secondly, additional memory is generally cheap and therefore increasing the amount is not burdensome.

The above discussion is meant to be illustrative of the principles and various embodiments of the present invention. Numerous variations and modifications will become apparent to those skilled in the art once the above disclosure is fully appreciated. For example, mobile computers or personal digital assistants (PDAs) may also benefit from the embodiments of this disclosure by having a wireless communications link. It is intended that the following claims be interpreted to embrace all such variations and modifications.

What is claimed is:

1. A wireless communication network with reduced handoff delay and simplified control of packet routing, comprising:
a plurality of cells including base stations;
a router including a microprocessor, a local memory, and a local storage, wherein said router is coupled to said plurality of basestations;
a home location register (HLR) coupled to the router, wherein said HLR directs said router; and
at least one mobile node communicating with one of said base stations in a first cell, wherein handoff data associated with transitioning the mobile node from the first cell to a second cell is broadcast to a list of cells.

2. The wireless communications network of claim 1, wherein the list of cells includes cells that are adjacent to the first cell.

3. The wireless communications network of claim 1, wherein the list of cells is generated by a prediction algorithm that gathers information about the location of the mobile node and current state of the network.

4. The wireless communications network of claim 1, wherein the handoff data is stored in the local memory of the router.

5. The wireless communications network of claim 4, wherein the handoff data is purged from memory after a predetermined period of time.

6. The wireless communications network of claim 4, wherein the handoff data is purged from memory when the mobile node actually transitions to its next cell.

7. A method of reducing delay and simplifying the control of packet routing associated with mobile node handoff within a wireless communications network, comprising:
locating a mobile node's current base station within a plurality of base stations;
determining a list of possible next base stations the mobile node can transition to; and
transmitting handoff data to the list of possible next base stations using a router coupled to said base stations;
wherein said router is under the direction of an HLR.

8. The method of claim 7, wherein the list of possible next base stations includes base stations that are adjacent to the mobile node's current base stations.

9. The method of claim 7, wherein the list of possible next base stations is generated using a prediction algorithm that gathers information about the location of the mobile node and current state of the network.

10. The method of claim 7, wherein the possible next base stations that receive the handoff data store it in local memory.

11. The method of claim 10, wherein the handoff data is purged from memory after a predetermined period of time.

12. The method of claim 11, wherein the next base stations discard the data if the predetermined period of time expires or if the mobile node receives the data.

13. A computer that may be used in routing data packets within a wireless network, comprising:
a processor;
a local memory; and
a storage medium;
wherein said processor, memory, and storage are coupled together and said computer is configured to receive handoff data for a mobile node located in a first cell, as well as additional handoff data for mobile nodes in other cells
wherein said computer is coupled to an HLR and is under direction of said HLR.

14. The computer of claim 13 wherein the additional handoff data comprises handoff data from mobile nodes located in other cells that are adjacent to the first cell.

15. The computer of claim 13, wherein the additional handoff data comprises handoff data from mobile nodes designated by a predictive algorithm.

16. The computer of claim 13, wherein the additional handoff data is stored in local memory.

17. The computer of claim 16, wherein the additional handoff data is purged from memory after a predetermined period of time.

18. The computer of claim 16, wherein the additional handoff data is purged from memory when the mobile node actually transitions to its next cell.
